(19) United States
(12) Patent Application Publication
(10) Pub. No.: US 2025/0365320 A1
(43) Pub. Date: Nov. 27, 2025

(54) MULTIMODAL CONTENT INTERPRETATION OF DIGITAL ASSETS

(71) Applicant: Aurascape, Santa Clara, CA (US)

(72) Inventors: Shayan Sadigh, Santa Clara, CA (US); Jean-Luc Nacif Coelho, Sunnyvale, CA (US); Ho Yu Lam, Santa Clara, CA (US); Xin Luo, Fremont, CA (US)

(21) Appl. No.: 19/214,751

(22) Filed: May 21, 2025

Related U.S. Application Data
(60) Provisional application No. 63/650,266, filed on May 21, 2024.
(60) Provisional application No. 63/650,254, filed on May 21, 2024.

(51) Int. Cl. H04L 9/40; G06F 16/683; G06F 40/30; G06V 20/40

(52) U.S. Cl. CPC H04L 63/20; G06F 16/685; G06F 40/30; G06V 20/46

(57) ABSTRACT

A method of managing a computer network includes: receiving, at a network port, a stream of multimodal data; obtaining, from the multimodal data, a subset of the multimodal data that corresponds to a modality; determining, using a large-language model (LLM) agent, a semantic context of the subset of the multimodal data; determining, based on the semantic context and among a plurality of network policies, a network security policy corresponding to the subset of the multimodal data; and directing the subset of the multimodal data according to the network security policy.

### CROSS REFERENCE TO RELATED DOCUMENTS

This application claims priority to and the benefit of U.S. Provisional Application No. 63/650,266 filed on May 21, 2024 and U.S. Provisional Application No. 63/650,254 filed on May 21, 2024, the entire contents of which are incorporated herein by reference.

### TECHNICAL FIELD

This disclosure relates generally to data security of computer networks.

### BACKGROUND

Computer networks are widely deployed for data transmission between computers. The transmitted data may correspond to contents presentable in different formats or associated with different contexts, such as text, image, video, and audio, with each format or context being a modality. Multimodal data typically refers to data that combines different modalities. For example, a message exchanged via a social media network may include both text and image data. In some applications, network security measures are deployed to ensure the data transmitted through a computer network does not contain unauthorized information.

### SUMMARY

Implementations of this disclosure utilize large-language model (LLM) agents to determine the semantic contexts of multimodal data to be transmitted in a computer network. The semantic contexts, which can be represented as text descriptions or tags, can be used to determine whether the multimodal data satisfy a network security policy. This way, multimodal data that includes unauthorized information can be blocked according to the network security policy, thereby improving data security of the computer network.

An aspect of the present disclosure provides a method of managing a computer network. The method includes: receiving, at a network port, a stream of multimodal data; obtaining, from the multimodal data, a subset of the multimodal data that corresponds to a modality; determining, using a large-language model (LLM) agent, a semantic context of the subset of the multimodal data; determining, based on the semantic context and among a plurality of network policies, a network security policy corresponding to the subset of the multimodal data; and directing the subset of the multimodal data according to the network security policy.

Another aspect of the present disclosure provides a system that includes one or more processors and a memory coupled to the one or more processors. The memory is configured to store instructions that, when executed, cause the one or more processors to perform operations including: receiving, at a network port, a stream of multimodal data; obtaining, from the multimodal data, a subset of the multimodal data that corresponds to a modality; determining, using an LLM agent, a semantic context of the subset of the multimodal data; determining, based on the semantic context and among a plurality of network policies, a network security policy corresponding to the subset of the multimodal data; and directing the subset of the multimodal data according to the network security policy.

Implementations of this disclosure can provide various technical advantages in the context of managing computer network security. For example, by analyzing semantic meanings of multimodal data including images, video, audio, and text prior to transmission (e.g., outbound from or inbound to a client device), overall data security can be enhanced. For instance, implementations in this disclosure can extract various data features, including structural, textual, and contextual features from the multimodal data and allow a computerized system to (i) determine, based on the extracted data features and an LLM agent, (ii) semantic meaning, (iii) generate semantic tags, (iv) classify the content into policy relevant categories, and/or (v) apply network security policies in real time.

These techniques can help the computerized system (which can also be a client device) to detect sensitive content which may be embedded in various formats such as screenshots of source code and confidential and/or personally identifiable information within the video data, audio data, and/or image data. Moreover, these techniques can allow the network security to block, redact, or allow the sensitive content based on its semantic meaning at the endpoint. As a result, the system can improve privacy, reduce the chance of data leaks, and adapt to new types of content or threats. Additional benefits can include reduced computer processing load and resources by avoiding or reducing repeated scans and monitoring of different types of data, manual flagging of issues, and manual review of flagged content, and by providing faster policy enforcement. These features can contribute to a more secure and efficient way to manage sensitive data in network security. Additional advantages and technical features are described in the detailed description section below.

### BRIEF DESCRIPTION OF DRAWINGS

FIG. 1 is a schematic diagram of a computing system that supports multimodal fingerprinting of digital assets according to some implementations.

FIG. 2 is a schematic diagram of a multimodal fingerprinting process performed by a network security service of a computing system according to some implementations.

FIG. 3 is an example image that has multimodal data according to some implementations.

FIG. 4 is a schematic diagram of an example of a content interpretation process according to some implementations.

FIG. 5 is a flowchart of an example of a content interpretation process according to some implementations.

FIG. 6 is a schematic diagram of a computer system that supports multimodal fingerprinting of digital assets according to some implementations.

Like reference numbers and designations in the drawings indicate like elements.

### DETAILED DESCRIPTION

Data breaches are a pervasive threat to organizations across industries, with the consequences ranging from financial losses to reputational damage. To determine whether multimodal data includes unauthorized information, content interpretation is often needed. Current content interpretation techniques often rely on heuristic-based algorithms or supervised machine learning models, which bucket text data into a set of predetermined classes, such as “piracy,” “chatbot,” and “spam.” These labels are fed to a policy algorithm, which determines an action to take on the content.

The existing content interpretation techniques are typically limited to interpreting text-only content. Thus, when a user converts text data into, e.g., image or video formats, existing content interpretation techniques are less likely to properly detect such data. Further, although techniques such as optical character recognition (OCR) can be used to recognize characters in an image file and convert the image file to a text document, OCR often lacks the capability of telling the semantic context of the data. Thus, even if text is recognized from a file, OCR still falls short from telling whether the text has unauthorized information (e.g., source code of a software package that is proprietary and confidential to an organization), as opposed to legitimate and authorized information (e.g., ordinary business communications).

This disclosure addresses the above problems. As described in detail below, a method of managing network security can leverage large-language model (LLM) agents to obtain semantic context from multimodal data and apply a network security policy to determine whether the data transmission is authorized.

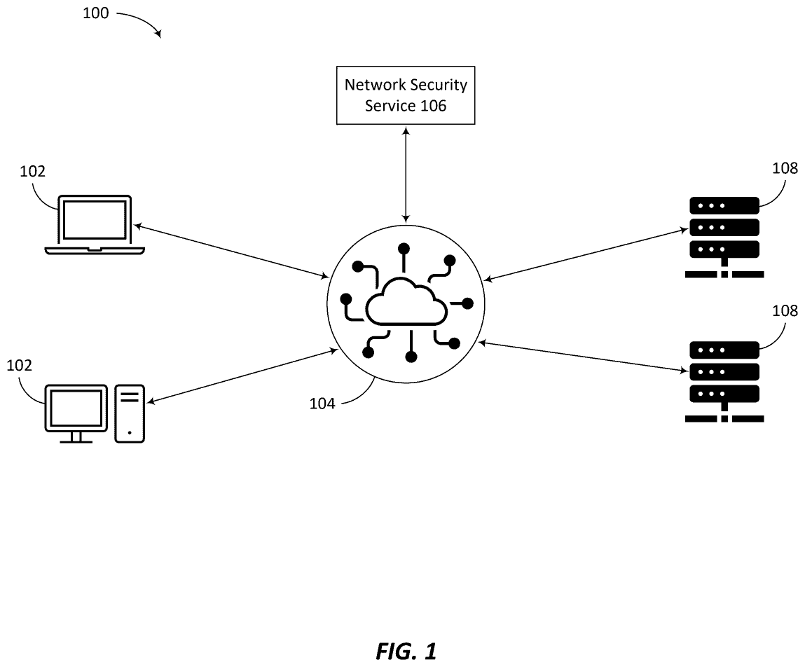

FIG. 1 is a schematic diagram of a computing system 100 that supports multimodal fingerprinting of digital assets and content interpretation process of multimodal data according to some implementations. The computing system 100 includes client devices 102, servers 108, and a network security service 106, which may communicate via a network 104. The network security service 106 is deployed in the network 104 and acts as a proxy for connections between the client devices 102 and the servers 108.

The network 104 may include one or more wired connections, such as copper cabling, fiber optics, or other conductive materials that form physical links between network endpoints. Additionally, or alternatively, the network 104 may include one or more wireless connections that employ radio frequency (RF) signals, infrared (IR) communications, or other non-tethered means for data transmission. In some examples, the network 104 is equipped with one or more routers, switches, and security gateways that manage the data traffic flow, enforce security policies, and maintain network integrity. The network 104 may be configured with mechanisms for error detection and correction, quality of service (QOS) management, and traffic prioritization to optimize the efficiency and reliability of data transmission across the network 104.

The client devices 102 can interface with the network 104 to access, process, or exchange data with other client devices 102 and servers 108. One or more of the client devices 102 can be configured to operate within a network environment that includes various other computing entities/resources. Each of the client devices 102 may include one or more processing units capable of executing instructions, one or more memory components for storing data and instructions, and communication hardware to facilitate wired or wireless connectivity in the network 104. Examples of client devices 102 include (but are not limited to) a portable handheld device, a wearable device, a desktop computer, or any other electronic device capable of sending and/or receiving data.

One or more of the client devices 102 can be equipped with one or more input mechanisms, such as a touchscreen interface, keyboard, mouse, stylus, or voice recognition sensors, to allow a user to interact with applications and services provided through the network. One or more of the client devices 102 can be equipped with one or more output mechanisms, such as a display screen, audio speakers, or haptic feedback devices to convey information to the user.

In some examples, one or more of the client devices 102 can be further equipped with power management components to optimize energy consumption, including a battery and power control logic. One or more of the client devices 102 can be configured to support various forms of network protocols and standards to ensure compatibility and interoperability with the broader network ecosystem. Software components installed on the client devices 102 can enable a range of functions from basic data processing and communication to advanced computational tasks, facilitated by the operating system and application software. One or more of the client devices 102 can have a modular design that allows for extensibility and upgrades through additional hardware or software modules, ensuring adaptability to evolving technologies and user requirements.

In some implementations, one or more of the client devices 102 are used by or associated with entities (e.g., employees) of an enterprise, such as an organization or a corporation. For example, the client devices 102 can be computers used by employees of an enterprise. In some implementations, one or more of the client devices 102 are used by individual users. For example, in such implementations, one or more of the client devices 102 can be personal computers of individual users.

In some implementations, one or more of the servers 108 are configured to manage, store, and disseminate data across the network 104. In some implementations, one or more of the servers 108 are comprised of high-performance hardware components including, but not limited to, one or more central processing units (CPUs) for executing programmatic instructions, volatile memory (RAM) for temporary data storage and rapid access, and non-volatile memory (such as HDDs or SSDs) for persistent data storage. In such implementations, these components are interconnected via a high-speed bus system and are housed within a chassis that is scalable to accommodate additional hardware resources as needed.

In some implementations, one or more of the servers 108 are configured to include network interface components that facilitate connectivity with various network topologies, supporting both wired and wireless communication standards to service multiple client devices concurrently. In some implementations, one or more of the servers 108 operate under a server operating system that manages system resources and provides a stable platform for server applications, including (but not limited to) web services, database management systems, file services, and application servers.

In some implementations, one or more of the servers 108 are configured with software-defined networking capabilities to allow for dynamic network configuration, optimizing data flow and resource allocation based on real-time network demands. In such implementations, the software-defined networking capabilities provide security mechanisms, featuring advanced encryption standards, secure access protocols, and an intrusion detection and prevention system (IDPS) to safeguard against unauthorized access and potential threats.

In some implementations, one or more of the servers 108 are capable of virtualization, creating multiple virtual machines (VMs) on a single physical hardware platform, each running distinct operating systems and applications. In such implementations, virtualization can be facilitated by a hypervisor, which abstracts processor, memory, storage, and other resources into multiple execution environments, which enhances server efficiency and flexibility in providing services.

In some implementations, one or more of the servers 108 are configured for scalability and high availability, with redundant power supplies, network connections, and storage systems to maintain operational continuity. Advanced management tools can be provided for configuring, monitoring, and maintaining the server's performance and health, which can be accessed locally or remotely, ensuring effective and efficient administration of network resources.

In some implementations, one or more of the servers 108 host applications that are used by the enterprise users. In some implementations, one or more of the servers 108 are associated with (e.g., owned, administrated) third-party providers. In some implementations, these applications include generative AI applications, such as ChatGPT, Google Bard, Replika, Jasper, Copy.ai, GitHub Copilot, DeepL Translator, DALL-E, Soundraw.io, AIVA, Runway ML, Chatbot services by IBM Watson, Zo Convert, etc. In some implementations, these applications include do-it-yourself (DIY) or custom enterprise AI applications, for example, based on a generative AI model such as Support CoPilot. In some implementations, the DIY enterprise applications are custom applications that are built internally at the enterprise.

In some implementations, the server applications hosted by the servers 108 include email, voice, video, or other textual data applications that incorporate generative AI tools or features, and the communications monitored by the network security service 106 include natural language data exchanged between the client devices 102 and various multimedia applications.

In some implementations, the network security service 106 is operable to safeguard communication networks from a spectrum of cyber threats and unauthorized access. In such implementations, the network security service 106 analyzes incoming and outgoing data traffic to ensure compliance with established security policies.

In some implementations, the network security service 106 includes one or more high-performance central processing units (CPUs) to manage the computational demands essential for inspecting and filtering substantial network traffic volumes. In some implementations, the network security service 106 include one or more memories, such as random-access memory (RAM), to facilitate the processing of active network connections and their associated security rulesets, as well as enabling rapid data retrieval. In some implementations, the network security service 106 includes multiple high-speed network interface cards (NICs) to interface with the network, supporting a range of bandwidth connections that may extend to 1 gigabyte per second (Gbps), 10 Gbps, or beyond. In some implementations, the network security service 106 includes a storage subsystem that utilizes flash memory or solid-state drives (SSDs) for the durable retention of the operating system, logs, configurations, and essential operational data.

In some implementations, the network security service 106 includes specialized security acceleration hardware to optimize cryptographic functions and bolster the performance of critical security operations, including encryption and decryption processes. In some implementations, the network security service 106 includes redundant power supplies to guarantee continuous functionality. In some implementations, the network security service 106 includes physical interfaces, such as universal serial bus (USB) ports for straightforward management, console ports for direct configuration, and, in some cases, high-definition multimedia interface (HDMI) ports for local display outputs.

In some implementations, the network security service 106 uses a multi-layered defense strategy consisting of a stateful firewall, an intrusion detection and prevention system (IDPS), and a deep packet inspection (DPI) engine. In such implementations, the firewall component operates by examining and filtering network traffic based on predetermined security rules, blocking or permitting data packets as they attempt to traverse the network boundary. The IDPS module monitors network activities for signs of malicious behavior, dynamically responding to potential threats by alerting system administrators and automatically taking preventative measures to thwart the attack. The DPI engine further enhances security measures by examining the data part of the traffic, beyond just the headers, allowing for a more granular analysis and real-time threat detection.

In some implementations, the network security service 106 is configured with an adaptive and modular architecture that allows for seamless integration of additional security functions such as antivirus filtering, anti-spam protection, virtual private network (VPN) management, and advanced content filtering. These security functions work in concert to detect and mitigate a variety of threats ranging from malware and phishing to network intrusions and data exfiltration attempts.

In some implementations, the network security service 106 is configured with an encryption framework that secures data transmission channels, preserving the confidentiality and integrity of sensitive information. User authentication mechanisms are embedded within the system, enforcing stringent access controls and user verification processes to ensure that only authorized personnel can access network resources.

In some implementations, the network security service 106 includes a management console that provides a centralized platform for configuring security parameters, monitoring network status, and analyzing logs and alerts generated by a security gateway. This console may support both local and remote management capabilities, enabling administrators to maintain optimal network security posture from any location.

The network security service 106 may be configured with advanced algorithms and machine learning techniques, allowing the network security service 106 to possess the capability to learn from traffic patterns, adapting security mechanisms in real-time to evolving threats. This proactive stance ensures that the network defense remains resilient and effective against sophisticated and emerging cyber threats.

In some implementations, the network security service 106 is deployed between client devices 102 and remote network servers 108 that the client devices 102 communicate with to use applications hosted by the servers 108. In such implementations, the network security service 106 is hosted in the network 104 and acts as a proxy in the network connections between the client devices 102 and the network servers 108.

In some implementations, the network security service 106 is provided with security credentials by the enterprise, enabling the network security service 106 to inspect the data in communications sessions between the client devices 102 and the server applications. In some examples, the data inspected by the network security service 106 includes natural language data. In some examples, the network security service 106 can process the data and perform security operations using one or more security large language models (LLMs).

The network security service 106 can be configured for easy insertion in a network connection between end user client devices 102 and remote server applications, and may be configured for capability evolution in dynamic environment. In some implementations, the network security service 106 is deployed as a man-in-the-middle between client devices 102 (e.g., members of a distributed enterprise) and remote server applications. In such implementations, the network security service 106 decrypts hypertext transfer protocol secure (HTTPS) sessions, processes the natural language contents of the HTTPS payload, and performs one or more security operations, such as: role-based access control; input query filtering for intellectual property, and sensitive data leakage, toxic language, personally identifiable information, and malicious queries; prompt generation and acceleration to reduce hallucinations; masking (anonymize) sensitive data; guarding against indirect prompt injections; and gaining visibility into user queries and/or application responses.

In some implementations, the network security service 106 uses field-programmable gate arrays (FPGAs), application-specific integrated circuits (ASICs), and other hardware to run one or more LLMs and/or to monitor natural language data between the client devices 102 and the servers 108.

In some implementations, the network security service 106 inspects natural language application traffic and provides security enforcement, which includes role-based access control, prompt generation and acceleration, data anonymization, guarding against indirect prompt injections, or moderating generative AI model responses, among other enforcement operations.

In some implementations, the network security service 106 implements one or more security LLMs as a cloud proxy. In such implementations, a security LLM is trained to implement security policies for natural language interactions, which includes processing natural language data and performing network security operations on the data based on the processing. The network security service 106 can provide a runtime security solution that processes data for multiple different third-party LLMs and LLM-based applications, including from vendor-specific LLMs, open-source LLMs, custom or tuned enterprise LLMs. The network security service 106 can also process third-party applications and/or DIY enterprise applications, among others.

In some implementations, a security LLM used by network security service 106 is an AI model with a large number of parameters, which can range from a few million to hundreds of billions. In such implementations, these parameters use a large number (e.g., hundreds) of leading-edge processing units and large amounts of time (e.g., weeks) to train, and a large number of processing units for inference. In some implementations, the processing units that are used by network security service 106 are realized using customized, task-specific silicon hardware and corresponding software. The hardware includes custom processors that are implemented in FPGAs or ASICs, among other suitable processing units. This hardware can be used to replace expensive graphical processing units (GPUs) from third-party vendors. In such implementations, the security LLM is supported by engineered hardware acceleration solutions (e.g., FPGAs or ASICs) that provide a highly performant and economical solution to the challenge of inspecting generative AI-bound application traffic and providing security enforcement. Accordingly, the network security service 106 can be configured for leading performance and highest scalability, while consuming a limited amount of power.

In some implementations, the network security service 106 is configured as a centralized repository and management console for security policies that dictate the security posture of an entire network infrastructure, to establish, manage, and distribute the security policies within the network environment. In some implementations, the network security service 106 includes one or more processing units and one or more memories. In such implementations, the one or more memories store instructions that, when executed by the processing units, facilitate the creation, modification, and enforcement of security policies. The network security service 106 can be equipped with a user interface that allows system administrators to intuitively interact with the policy server to define, update, and retire security policies as threats evolve or business requirements change.

In some implementations, the network security service 106 further includes a communication module to facilitate secure communication with the network security service 106. The communication module can ensure that policy updates are delivered in a secure and reliable manner, employing encryption and integrity checks to prevent unauthorized access or tampering in transit.

In some implementations, the network security service 106 is operable to receive feedback from the network 104 regarding the enforcement of the security policies and the observed network traffic. Such feedback can include logs, alerts, and metrics, which the network security service 106 can use to automatically refine or suggest modifications to the existing policies, thus enabling dynamic security management.

In some implementations, the network security service 106 is integrated with external data sources, such as threat intelligence feeds, to automatically update security policies in response to emerging threats. This proactive capability ensures that the network security service 106 is equipped with the most current and effective set of rules to defend against the latest security vulnerabilities and attack vectors.

In some implementations, the network security service 106 is capable of streamlining the administration of network security by serving as the authoritative system for policy lifecycle management, from policy creation through deployment and monitoring to policy decommissioning. This centralized control plane simplifies the complexity associated with managing distributed security infrastructure and provides a single point of reference for audit and compliance processes.

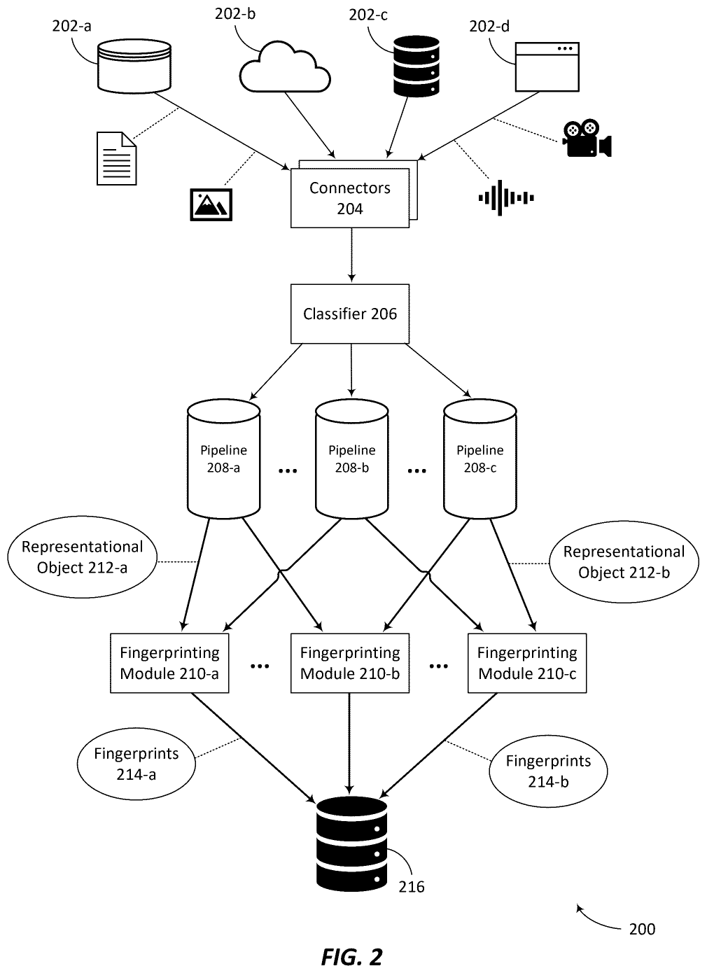

FIG. 2 is a schematic diagram of a multimodal fingerprinting process 200 performed by the network security service 106 depicted in FIG. 1 according to some implementations. As described herein, the network security service 106 includes one or more data source connectors 204 that support integration with various user-defined data sources 202, such as a local file store 202-a, a data lake 202-b, a file hosting service 202-c, a public data source 202-d, etc. The network security service 106 also includes an automatic input classifier 206 that identifies input type and format (e.g., tabular data, audio, video) and detects the specific kind of data encoding.

Additionally, the network security service 106 includes object extraction pipelines 208 that specialize in a particular file type. These pipelines extract informational tags from the data being scanned, such as proprietary computer code, internal design diagrams, financial information, etc. The network security service 106 can include an object extraction pipeline 208-a that specializes in design files (e.g., computer-aided design (CAD) files, chip design files), and an object extraction pipeline 208-b that specializes in video files, an object extraction pipeline 208-c that specializes in audio files. Other object extraction pipelines 208 may specialize in binary files, images, code files, text files, etc.

The object extraction pipelines 208 can extract representational data objects 212 from the unstructured data files. For example, the object extraction pipeline 208-a can extract representational data objects 212-a (such as vectors, text, or other custom geometric representations) from design files. The object extraction pipeline 208-b can extract frames, audio data, text, or diagrams from video files. The object extraction pipeline 208-c can extract representational data objects 212-b (such as raw bytes, text, or images) from audio files. Additionally, or alternatively, one of the object extraction pipelines 208 may be configured to extract pixel matrices, vectors, or text from image files, one of the object extraction pipelines 208 may be configured to extract raw text, graph structures, or binary files from code files, and one of the object extraction pipelines 208 may be configured to extract raw byte arrays, structured data, or computer instructions from binary files.

The representational data objects 212 extracted by the object extraction pipelines 208 are sent to fingerprinting modules 210 that each specialize in a particular data/object type. In some implementations, one fingerprinting module 210-a may specialize in text, another fingerprinting module 210-b may specialize in graph structures, and another fingerprinting module 210-c may specialize in video frames. The fingerprinting modules 210 use algorithms and other machine learning techniques to generate a set of multimodal fingerprints 214 for each unstructured data file. The multimodal fingerprints 214 are irreversible representations of the underlying data, meaning the multimodal fingerprints 214 cannot be used to recreate the original file.

Each fingerprinting module 210 reads a particular data type and generates multimodal fingerprints 214 for that data type. For example, a fingerprinting module 210-a may generate a set of multimodal fingerprints 214-a for an audio file, and a fingerprinting module 210-c may generate a set of multimodal fingerprints 214-b for a video file. The multimodal fingerprints 214 are then stored in a searchable database 216, along with any metadata tags generated by the object extraction pipelines 208. This database 216 is used to determine (i) whether a given set of multimodal fingerprints 214 belong to a proprietary or sensitive data source or (ii) how similar a particular file/object is to other proprietary or sensitive data scanned by the network security service 106.

The multimodal fingerprints 214 are configured such that two fingerprints 214 generated from similar content can be matched/correlated, regardless of the medium from which the content originated. Additionally, the network security service 106 scans public facing data from user-defined data sources 202 and other general knowledge databases. This data is fingerprinted in a similar manner, but with no constraint on the fingerprints 214 being irreversible. This public facing set of fingerprints 214 can then be used to match/correlate data and reduce false positives in proprietary data detection.

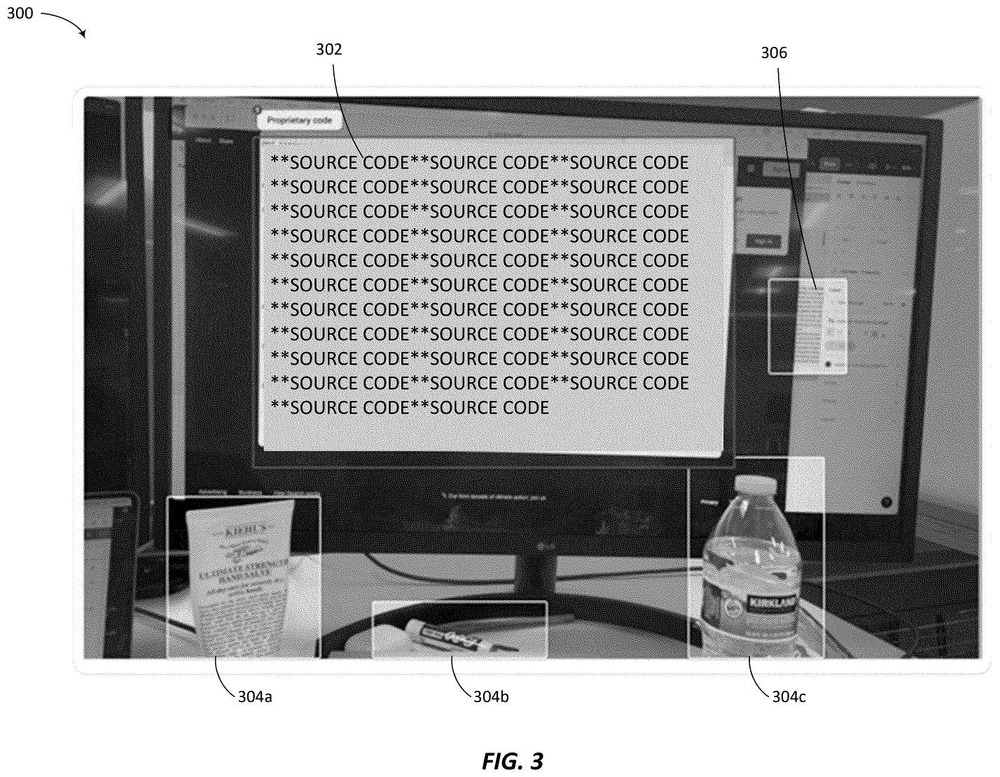

FIG. 3 is an example image 300 that has multimodal data according to some implementations. A user can transmit image 300 in a computer system, such as system 100 of FIG. 1, over a computer network.

In image 300, there is provided a computer monitor displaying source code 302 on the screen. Also on the screen is an open window 306 of another computer application. Image 300 also shows several objects of personal items or office supplies, such as a marker 304b, a bottle of water 304c, and a lotion container 304a. As such, when image 300 is transmitted in the computer network, the data can include one or more of the following modalities: the image showing the monitor and other objects, the source code in the text format transmitted over the image modality, the text of other computer applications in the text format transmitted over the image modality, and the text on each of the marker, the bottle, and the lotion container, in the text format transmitted over the image modality.

Assuming the source code is proprietary and confidential, a network security policy can specify that transmission of the source code is unauthorized. On the other hand, the network security policy can specify that transmission of data corresponding to the other displayed contents is harmless and authorized. When the user attempts to send image 300 over a network firewall, existing techniques may be unable to identify the source code from the other contents of image 300.

In some implementations, one or more LLM agents can be utilized to process image 300 and extract natural language descriptions and/or generate tags associated with the multimodal contents. For example, an LLM agent can be tasked or trained to recognize the source code based on the syntax, coding style, and surrounding features (e.g., boundaries of a computer screen), while another LLM agent can be tasked or trained to recognize the commercial text displayed on the lotion container based on the text color, the text content, and the display location. Likewise, an LLM agent can be tasked or trained to distinguish the source code from the other text also displayed on the computer screen. Accordingly, the LLM agents can determine the semantic contexts corresponding to each modality shown in image 300.

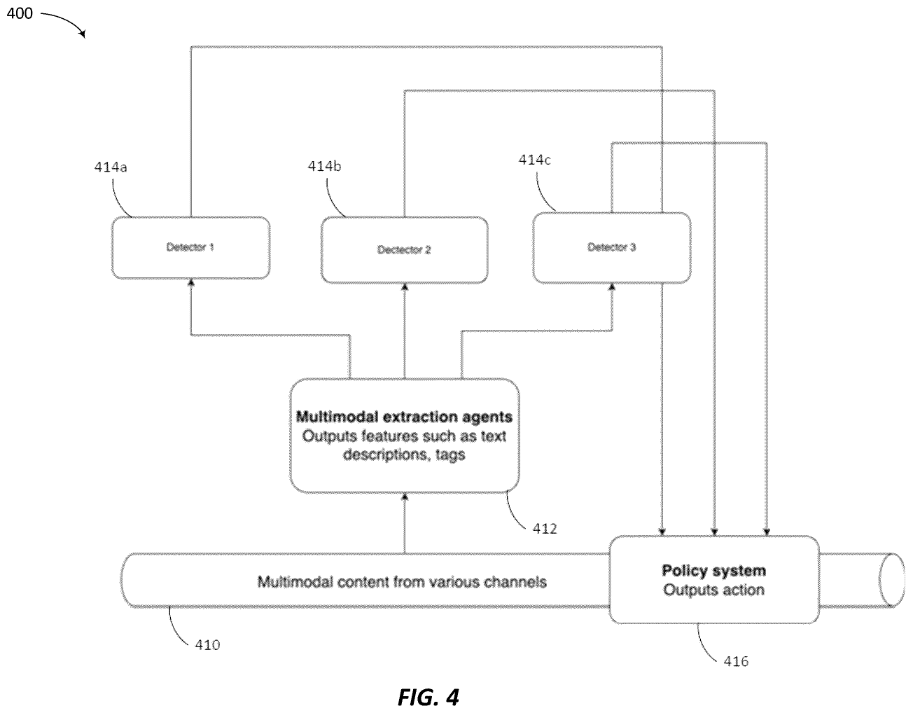

FIG. 4 is a diagram of an example content interpretation process 400 according to some implementations. The process 400 can be implemented by a processor-based system, such as the computing system 100, a client device 102, or a computer system 600, and in conjunction with the implementations described in this disclosure.

At 410, multimodal data (e.g., image 300) is received at a network port from one or more channels for transmission through a computer network.

At 412, LLM agents, or other similar machine learning model(s), are deployed to tag multimodal data and extract the semantic content corresponding to each tag as features. In the example of image 300, source code 302, window 306, and objects 304a-304c generate tags such as “source code” and “consumer product branding” and corresponding features such as source code text and consumer product branding text can be extracted from the image modality by an LLM agent. The extracted features are passed to detectors 414a-414c to determine whether unauthorized information is included in the data subset. Each of detectors 414a-414c can make a determination regarding the unauthorized information based on the semantic context and a network security policy. For example, detector 414a can be configured to determine whether source code 302 contains proprietary or confidential information that violates the network security policy of data transmission. Similarly, detector 414b can be configured to determine whether information on container 304a contains proprietary or confident information that violates the network security policy.

Depending on the detection results, the computer network can direct the multimodal data according to one or more output actions 416 specified by the network security policy. For example, if no unauthorized data transmission is detected, the firewall of the computer network can allow the multimodal data to pass. Otherwise, the firewall can direct the data containing unauthorized information to a designated unit for source code leak analysis and/or proprietary information analysis, block the transmission, and/or notify security personnel. The analyses can be based on the fingerprint generated by fingerprinting process 200. More details about the fingerprinting process can be found in U.S. Provisional Application No. 63/650,266 filed on May 21, 2024, which is incorporated herein by reference.

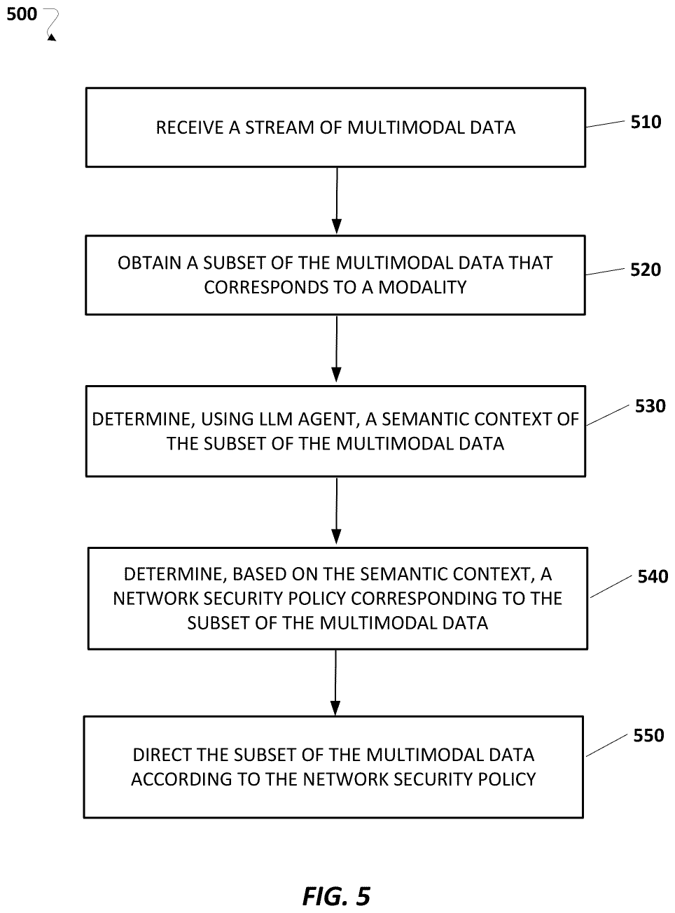

FIG. 5 is a flowchart of a content interpretation process 500 according to some implementations. The process 500 can be implemented by a processor-based system, such as the computing system 100, a client device 102, or a computer system 600, and in conjunction with the process 400 and implementations described in this disclosure.

At 510, a stream of multimodal data is received at a network port. The multimodal data can include content from one or more modalities, such as image, video, audio, or text. In some implementations, the stream of multimodal data can originate or can be from a client device (e.g., the client device 102) and can be directed outbound through the network port toward an external destination. Moreover, for instance, the network port can correspond to a communication endpoint on the system (e.g., the computing system 100, a client device 102, or a computer system 600). In some examples, the network port can be a part of a firewall, proxy server, or other network interface that can manage inbound or outbound data transmission, allowing the system to inspect, filter, or direct data based on security policies.

At 520, a subset of the multimodal data that corresponds to a modality is obtained. In some examples, the subset of the multimodal data can correspond to a video data. In some examples, the subset of the multimodal data can correspond to an audio data. In some examples, the subset of the multimodal data can correspond to a text data. For instance, the subset can be obtained or extracted by identifying and separating data from the multimodal data based on its format or structure. For example, the extraction process can use content identification or data extraction techniques, such as analyzing data structure, format indicators, or embedded metadata, to thereby separate and isolate the relevant type of content from the overall multimodal stream. For instance, the extraction process can use format-specific parsing, metadata tagging, or signal separation techniques to isolate the relevant modality from the original multimodal stream.

In some implementations, when the subset corresponds to the video data, the video data can be further processed to obtain key video frames and the associated audio. Key video frames can be identified by detecting one or more structural changes relative to adjacent frames, where the change exceeds a threshold that is determined based on one or more visual difference metrics including a structural similarity index. For instance, the key video frames can correspond to frames that differ from adjacent frames by the one or more structural changes that exceed such threshold. Moreover, the audio aligned with the key frames can be extracted and transcribed into text, for example, by using a speech recognition engine.

In some implementations, when the subset corresponds to the audio data, the audio can be transcribed into text, for example, by using a speech recognition engine before further processing.

In some implementations, the extracted key frames and transcribed audio can be combined or appended prior to semantic context determination. When the subset is audio only, the resulting transcript can serve as the input for semantic analysis. As described below with respect to step 530, an LLM agent can determine the semantic context of the content based on both visual and textual features, or on transcribed text in the case of audio only inputs.

At 530, a semantic context of the subset of the multimodal data is determined by using one or more LLM agents. In some implementations, the LLM agent can correspond to an LLM agent that is trained based on various features, including code syntax, screen layout, text formatting, content, visual context, etc.

In some implementations, determining the semantic context of the subset of the multimodal data can include generating, by using the LLM agent(s), one or more semantic tags for the subset of the multimodal data, the semantic tags corresponding to semantic features including object type, content topic, or information that facilitates interpretation of semantic content included in the subset. Moreover, such determination step can further include classifying the subset into one or more policy relevant categories based on the one or more semantic tags, where the policy relevant categories include at least one of (i) proprietary source code, (ii) confidential financial information, (iii) personally identifiable information, and (iv) non-sensitive content. In some examples, the classified one or more policy relevant categories can be generated or determined for each corresponding semantic tag of the subset, after generating the semantic tags. In some examples, the classified one or more policy relevant categories can be embedded within, or correspond to, one or more of the semantic tags as part of the semantic tag generation step. In some examples, classifying the subset into one or more policy relevant categories can be a separate determination step that takes part of step 540 (e.g., network security policy determination step). Moreover, throughout this disclosure, classifying the subset into one or more policy relevant categories can also correspond to determining the one or more policy relevant categories for each content or semantic tag of one or more portions of the subset.

In some implementations, determining the semantic context of the subset of the multimodal data can include, determining, by using the LLM agent(s), the semantic context of the subset of the video stream based on a combination of the text and the key video frames.

In some examples, the LLM agent(s) can be trained to differentiate between source code and debug logs visible in the same image, or to recognize handwritten code on a whiteboard from a photo taken at odd angles and with reflections. In some implementations, the LLM agent(s) can be trained to recognize and extract, from an image of a meeting room with a whiteboard and a screenshare in the background, software code on the whiteboard and system design block diagrams from the screenshare. The LLM agent(s) can tag each extracted piece of information as “sensitive software code” or “internal design block diagram.”

In some examples, the LLM agent(s) can be tasked or trained to recognize and extract discussion about financial information from a video recording of a company's internal meeting. The LLM agent(s) can tag each extracted piece of information as “publicly available financial information,” “insider knowledge about financial forecasts,” or “company secrets about roadmaps.”

In some examples, the LLM agent(s) can be tasked or trained to recognize and extract, from an audio file from an external VoIP call, oral discussion between two engineers about source code and proprietary information. The LLM agent(s) can tag each extracted piece of information as “discussion of sensitive information” or “discussion of non-work related information.”

In some implementations, the LLM agent(s) can process content that resembles examples shown in FIG. 3. For instance, when the subset contains an image of a screen displaying source code and consumer product, the LLM agent(s) can tag one or more portions accordingly based on both content and visual structure. In some examples, the LLM agent can be trained, based on code syntax, layout features, and style indicators such text size, font, color, or the like, in addition to content of the text. Based on these inputs, the LLM agent can generate semantic tags that describe object types, content categories, or other semantic features. In some examples, one or more portions of the subset can be classified into the one or more policy relevant categories, as described above.

At 540, a network security policy corresponding to the subset of the multimodal data is determined based on the semantic context and among a plurality of network policies. For example, the network security policy can indicate whether the subset is authorized for transmission (e.g., such that the content can be forwarded to its destination) or that the subset is unauthorized (e.g., such that the transmission can be blocked).

In some implementations, determining the network security policy corresponding to the subset of the multimodal data can include: after or in response to classifying the subset into the one or more policy relevant categories, determining the network security policy corresponding to the subset based on the one or more policy relevant categories. In some examples, as described above with respect to step 530, the one or more classified policy relevant categories can be embedded within, or correspond to, one or more of the semantic tags as part of the semantic tag generation step. Further, in some examples, as described above with respect to step 530, classifying the subset into one or more policy relevant categories can be a separate determination step that takes part of this step 540 after the semantic tags have been generated at step 530.

In some implementations, determining the network security policy corresponding to the subset of the multimodal data can include determining the network security policy based on the unauthorized categories of the policy relevant categories. For instance, a list of unauthorized categories or a list of policy relevant category including the unauthorized categories can be retrieved from a memory of the client device or a memory of a server and compared with the classified (or determined) one or more policy relevant categories.

In some implementations, within the subset, one or more portions that match one or more unauthorized categories of the policy relevant categories can be identified. For instance, determining the network security policy can include comparing (i) the one or more classified policy relevant categories corresponding to one or more portions of the subset to (ii) a list of unauthorized categories and determining the security policy based on the comparison. In some examples, the one or more portions of the subset can correspond to one or more segments within the subset.

In some implementations, within the subset, one or more portions of the subset that match one or more unauthorized categories of the policy relevant categories can be identified prior to the network security policy determination step. For instance, independently from the network security policies or determining step therein, the one or more classified policy relevant categories generated or determined from the step 530 can be compared to a list of unauthorized categories prior to the network security policy determination step.

In some cases where the one or more portions that match one or more unauthorized categories are identified prior to the network security policy determination step of 540, after or in response to identifying the one or more portions of the subset that match one or more unauthorized categories, the subset can be modified by redacting or masking unauthorized content within the one or more portions of the subset. In some examples, determining the network security policy at step 540 corresponding to the subset of the multimodal data can include determining the network security policy corresponding to the modified subset of the multimodal data. In some examples, the subset can be modified automatically, or modified after presenting a user with an option (for user display) to modify (redact or mask) the content and after the user approving the option. For instance, data indicating (i) that the one or more portions contain the one or more unauthorized categories for user display and (ii) an option for modification of the one or more portions within the subset based on redaction or masking of unauthorized content within the one or more portions, can be transmitted to a display of the processor-based system (such as the client device). For example, based on receiving a user input indicating a request (e.g., approval) for the modification, unauthorized content within the one or more portions of the subset can be modified accordingly. In some examples, after or in response to the modification, the network security policy corresponding to the subset of the multimodal data can be determined based on the modified subset.

In some implementations where the one or more portions that match one or more unauthorized categories are identified as part of the network security policy determination step 540, after or in response to determining the network security policy that indicates that the subset is unauthorized for transmission, the processor-based system can present a user with an option (for user display) to modify the content. For instance, after determination of the network security policy corresponding to the subset, which indicates that transmission of the subset of the multimodal data is unauthorized, data indicating (i) that the one or more portions contain the one or more unauthorized categories for user display and (ii) an option for modification of the one or more portions within the subset based on redaction or masking of unauthorized content within the one or more portions, can be transmitted to a display of the processor-based system (such as the client device). For example, based on receiving a user input indicating a request (e.g., approval) for the modification, unauthorized content within the one or more portions of the subset can be modified accordingly. In some examples, after or in response to the modification, the network security policy corresponding to the subset of the multimodal data can be determined based on the modified subset.

At 550, the subset of the multimodal data is directed according to the network security policy. For instance, directing the subset of the multimodal data can include or correspond to controlling transmission of the subset of the multimodal data based on the network security policy.

In some implementations, when the network security policy indicates that transmission of the subset of the multimodal data is authorized, the subset of the multimodal data can be directed to an address specified in the stream of multimodal data.

Ine some implementations, when the network security policy indicates that transmission of the subset of the multimodal data is unauthorized, the transmission regarding the subset of the multimodal data can be blocked.

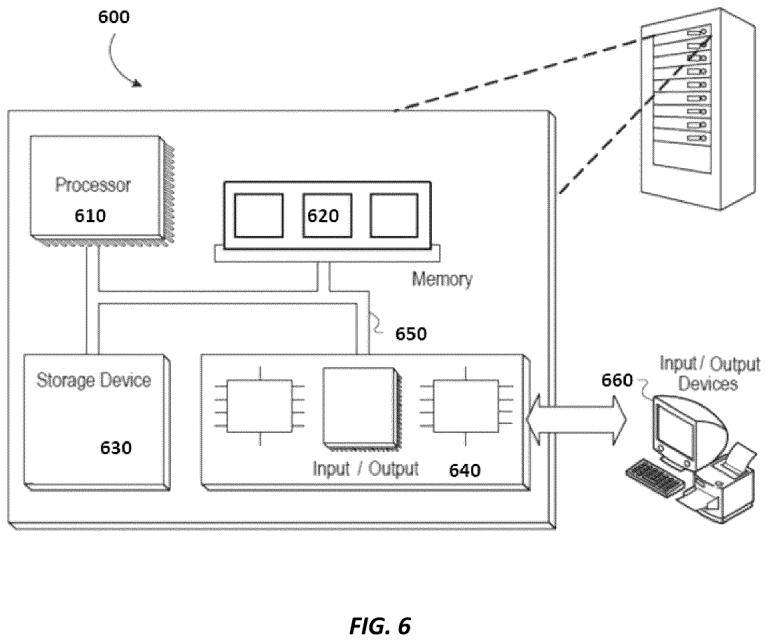

FIG. 6 is a schematic diagram of an example computer system 600. In some implementations, the computer system 600 may include or be a part of one or more of the entities described herein, such as the client devices 102, the network security service 106, the servers 108, the database 216, etc. As depicted in FIG. 6, the computer system 600 includes a processor 610, a memory 620, a storage device 630 and an input/output device 640. Each of these components can be interconnected, for example, by a system bus 650. The processor 610 is capable of processing instructions for execution within the computer system 600. In some implementations, the processor 610 is a single-threaded processor, a multi-threaded processor, or another type of processor. The processor 610 is capable of processing instructions stored in the memory 620 or on the storage device 630. The memory 620 and the storage device 630 can store information within the system 600. Although the computer system 600 is shown as having one processor 610, one memory 620, and one storage device 630 for illustrative purposes, the computer system 600 can include any number of processors 610, memories 620, and storage devices 630 based on system requirements.

The input/output device 640 provides input/output operations for the computer system 600. In some implementations, the input/output device 640 can include one or more of a network interface device (for example, an Ethernet card), a serial communication device (for example, an RS-232 port), or a wireless interface device (for example, an 802.11 card, a 3G wireless modem, a 4G wireless modem, or a 5G wireless modem), or some combination thereof. In some implementations, the input/output device can include driver devices configured to receive input data and send output data to other input/output devices, for example, a keyboard, printer, and/or display devices 660. In some implementations, mobile computing devices, mobile communication devices, and other devices can also be used.

While the present disclosure describes many examples, these should not be construed as limitations on the scope of an invention that is claimed or of what may be claimed, but rather as descriptions of features specific to particular embodiments. Certain features that are described in the context of separate embodiments can also be implemented in combination in a single embodiment. Conversely, various features that are described in the context of a single embodiment can also be implemented in multiple embodiments separately or in any suitable sub-combination. Although some features may be described as acting in certain combinations and even initially claimed as such, one or more features from a claimed combination in some cases can be excised from the combination, and the claimed combination may be directed to a sub-combination or a variation of a sub-combination. Similarly, while some operations may be depicted in the drawings in a particular order, this should not be understood as requiring that such operations are performed in the particular order shown or in sequential order, or that all illustrated operations be performed, to achieve desirable results.

A number of embodiments have been described. Nevertheless, it is understood that various modifications can be made without departing from the spirit and scope of the present disclosure. Accordingly, other embodiments are within the scope of the following claims.

What is claimed is:

1. A method of managing a computer network, comprising:
receiving, at a network port, a stream of multimodal data;
obtaining, from the multimodal data, a subset of the multimodal data that corresponds to a modality;
determining, using a large-language model (LLM) agent, a semantic context of the subset of the multimodal data;
determining, based on the semantic context and among a plurality of network policies, a network security policy corresponding to the subset of the multimodal data; and
directing the subset of the multimodal data according to the network security policy.

2. The method of claim 1, wherein directing the subset of the multimodal data comprises:
controlling transmission of the subset of the multimodal data based on the network security policy.

3. The method of claim 1, wherein the network security policy indicates that transmission of the subset of the multimodal data is authorized, and wherein the subset of the multimodal data is directed to an address specified in the stream of multimodal data.

4. The method of claim 1, wherein the network security policy indicates that transmission of the subset of the multimodal data is unauthorized, and wherein directing the subset of the multimodal data comprises blocking the transmission of the subset of the multimodal data.

5. The method of claim 1, wherein the subset of the multimodal data comprises a video stream,
wherein the method further comprises:
extracting a plurality of key video frames from the video stream, the key video frames corresponding to frames that differ from adjacent frames by a structural change that exceeds a threshold, where the threshold is determined based on one or more visual difference metrics including a structural similarity index,
extracting an audio stream temporally aligned with the key video frames, and
transcribing the audio stream into text; and
wherein determining the semantic context of the subset of the multimodal data comprises:
determining, by using the LLM agent, the semantic context of the subset of the video stream based on a combination of the text and the key video frames.

6. The method of claim 1, wherein determining the semantic context of the subset of the multimodal data comprises:
generating, by using the LLM agent that is trained based on features including one or more of code syntax, screen layout, text formatting, content, or visual context, one or more semantic tags for the subset of the multimodal data, wherein the semantic tags correspond to semantic features including at least one of object type, content topic, or information associated with interpretation of semantic content of the subset; and
classifying the subset into one or more policy relevant categories based on the one or more semantic tags, the policy relevant categories including at least one of (i) proprietary source code, (ii) confidential financial information, (iii) personally identifiable information, or (vi) non-sensitive public content.

7. The method of claim 6, wherein determining the network security policy corresponding to the subset of the multimodal data comprises:
in response to classifying the subset into the one or more policy relevant categories, determining the network security policy corresponding to the subset based on the one or more policy relevant categories.

8. The method of claim 6, further comprising:
identifying, within the subset, one or more portions that match one or more unauthorized categories of the policy relevant categories; and
in response to identifying the one or more portions, modifying the subset by at least one of redacting or masking unauthorized content within the one or more portions of the subset, and
wherein determining the network security policy corresponding to the subset of the multimodal data comprises:
determining the network security policy corresponding to the modified subset of the multimodal data.

9. The method of claim 6, further comprising:
identifying, within the subset, one or more portions that match one or more unauthorized categories of the policy relevant categories, wherein determining the network security policy corresponding to the subset of the multimodal data comprises determining the network security policy based on the unauthorized categories of the policy relevant categories,
in response to the network security policy corresponding to the subset indicates that transmission of the subset of the multimodal data is unauthorized, transmitting, to a display of a user device, data indicating (i) that the one or more portions contain the one or more unauthorized categories for user display and (ii) an option for modification of the one or more portions within the subset based on at least one of redaction or masking of unauthorized content within the one or more portions, and
based on receiving a user input indicating a request for the modification, modifying unauthorized content within the one or more portions of the subset.

10. The method of claim 6, further comprising:
identifying, within the subset, one or more portions that match one or more unauthorized categories of the policy relevant categories, wherein determining the network security policy corresponding to the subset of the multimodal data comprises determining the network security policy based on the unauthorized categories of the policy relevant categories, wherein the network security policy corresponding to the subset indicates that transmission of the subset of the multimodal data is unauthorized,
in response to identifying the one or more portions that match one or more unauthorized categories of the policy relevant categories and prior to determining the network security policy corresponding to the subset of the multimodal data,
transmitting, to a display of a user device, data indicating (i) that the one or more portions contain the one or more unauthorized categories and (ii) an option for modification of the one or more portions within the subset based on at least one of redaction, masking, or replacement of unauthorized content within the one or more portions, and
based on receiving a user input indicating a request for the modification, modifying unauthorized content within the one or more portions of the subset.

11. A system comprising: one or more processors; and a memory coupled to the one or more processors, wherein the memory is configured to store instructions that, when executed, cause the one or more processors to perform operations including:
receiving, at a network port, a stream of multimodal data;
obtaining, from the multimodal data, a subset of the multimodal data that corresponds to a modality;
determining, using a large-language model (LLM) agent, a semantic context of the subset of the multimodal data;
determining, based on the semantic context and among a plurality of network policies, a network security policy corresponding to the subset of the multimodal data; and
directing the subset of the multimodal data according to the network security policy.

12. The system of claim 11, wherein directing the subset of the multimodal data comprises:
controlling transmission of the subset of the multimodal data based on the network security policy.

13. The system of claim 11, wherein the network security policy indicates that transmission of the subset of the multimodal data is authorized, and wherein the subset of the multimodal data is directed to an address specified in the stream of multimodal data.

14. The system of claim 11, wherein the network security policy indicates that transmission of the subset of the multimodal data is unauthorized, and wherein directing the subset of the multimodal data comprises blocking the transmission of the subset of the multimodal data.

15. The system of claim 11, wherein the subset of the multimodal data comprises a video stream,
wherein the operations further comprise:
extracting a plurality of key video frames from the video stream, the key video frames corresponding to frames that differ from adjacent frames by a structural change that exceeds a threshold, where the threshold is determined based on one or more visual difference metrics including a structural similarity index,
extracting an audio stream temporally aligned with the key video frames, and
transcribing the audio stream into text; and
wherein determining the semantic context of the subset of the multimodal data comprises:
determining, by using the LLM agent, the semantic context of the subset of the video stream based on a combination of the text and the key video frames.

16. The system of claim 11, wherein determining the semantic context of the subset of the multimodal data comprises:
generating, by using the LLM agent that is trained based on features including one or more of code syntax, screen layout, text formatting, content, or visual context, one or more semantic tags for the subset of the multimodal data, wherein the semantic tags correspond to semantic features including at least one of object type, content topic, or information associated with interpretation of semantic content of the subset; and
classifying the subset into one or more policy relevant categories based on the one or more semantic tags, the policy relevant categories including at least one of (i) proprietary source code, (ii) confidential financial information, (iii) personally identifiable information, or (vi) non-sensitive public content.

17. The system of claim 16, wherein determining the network security policy corresponding to the subset of the multimodal data comprises:
in response to classifying the subset into the one or more policy relevant categories, determining the network security policy corresponding to the subset based on the one or more policy relevant categories.

18. The system of claim 16, wherein the operations further comprise:
identifying, within the subset, one or more portions that match one or more unauthorized categories of the policy relevant categories; and
in response to identifying the one or more portions, modifying the subset by at least one of redacting or masking unauthorized content within the one or more portions of the subset, and
wherein determining the network security policy corresponding to the subset of the multimodal data comprises:
determining the network security policy corresponding to the modified subset of the multimodal data.

19. The system of claim 16, wherein the operations further comprise:
identifying, within the subset, one or more portions that match one or more unauthorized categories of the policy relevant categories, wherein determining the network security policy corresponding to the subset of the multimodal data comprises determining the network security policy based on the unauthorized categories of the policy relevant categories,
in response to the network security policy corresponding to the subset indicates that transmission of the subset of the multimodal data is unauthorized, transmitting, to a display of a user device, data indicating (i) that the one or more portions contain the one or more unauthorized categories for user display and (ii) an option for modification of the one or more portions within the subset based on at least one of redaction or masking of unauthorized content within the one or more portions, and
based on receiving a user input indicating a request for the modification, modifying unauthorized content within the one or more portions of the subset.

20. The system of claim 16, wherein the operations further comprise:
identifying, within the subset, one or more portions that match one or more unauthorized categories of the policy relevant categories, wherein determining the network security policy corresponding to the subset of the multimodal data comprises determining the network security policy based on the unauthorized categories of the policy relevant categories, wherein the network security policy corresponding to the subset indicates that transmission of the subset of the multimodal data is unauthorized,
in response to identifying the one or more portions that match one or more unauthorized categories of the policy relevant categories and prior to determining the network security policy corresponding to the subset of the multimodal data,
transmitting, to a display of a user device, data indicating (i) that the one or more portions contain the one or more unauthorized categories and (ii) an option for modification of the one or more portions within the subset based on at least one of redaction, masking, or replacement of unauthorized content within the one or more portions, and
based on receiving a user input indicating a request for the modification, modifying unauthorized content within the one or more portions of the subset.
